(19) United States
(12) Patent Application Publication
(10) Pub. No.: US 2025/0362697 A1
(43) Pub. Date: Nov. 27, 2025

(54) VOLTAGE REGULATOR

(71) Applicant: WILL SEMICONDUCTOR (SHANGHAI) CO. LTD., SHANGHAI (JP)

(72) Inventor: MANABU ISHIDA, RIFU-CHO (JP)

(21) Appl. No.: 18/889,132

(22) Filed: Sep. 18, 2024

(30) Foreign Application Priority Data
May 22, 2024 (JP) 2024-083343

(51) Int. Cl. G05F 1/575

(52) U.S. Cl. CPC G05F 1/575

(57) ABSTRACT

A voltage regulator outputs a target voltage corresponding to a reference voltage Vref from a power-supply voltage Vin. The voltage regulator includes a feedback loop circuit, in which the reference voltage Vref is input, a feedback voltage after an output voltage Vout is divided is fed back, and the output voltage is controlled in correspondence with the reference voltage; and a voltage-dividing ratio changing circuit, which changes the feedback voltage by changing a voltage-dividing ratio of the output voltage Vout. When the power-supply voltage Vin drops and the target voltage cannot be maintained, the feedback voltage is increased according to the power-supply voltage by the voltage-dividing ratio changing circuit, thereby reducing the target voltage.

### BACKGROUND OF THE INVENTION

### 1. Field of the Invention

The disclosure relates to a voltage regulator that outputs a target voltage corresponding to a reference voltage from a power-supply voltage.

### 2. Description of the Related Art

In semiconductor integrated circuits such as integrated circuits (ICs), a voltage regulator may be arranged to obtain an internal power-supply of a predetermined voltage from an external power-supply. As long as a large-capacity output capacitor is arranged at the output of the voltage regulator, the voltage of an internal power-supply line can be stabilized, but the circuit scale will become large. Therefore, it is common practice not to arrange the output capacitor.

### PRIOR ART DOCUMENTS

### Patent documents

[Patent document 1] U.S. Pat. No. 9,983,607B1

[Patent document 2] US 2007/0018623A1

### SUMMARY OF THE INVENTION

### Problems to be Solved

Here, in the voltage regulator, an overshoot is likely to occur when the voltage of the external power-supply fluctuates greatly to the extent that temporarily drops below a target value of the output and then returns to a normal range again. This is because a loop of feedback control is temporarily broken and an output driver goes into the full-on state, and as a result, it takes time to return to the control state again.

In addition, the overshoot can be prevented by a zener diode, or a circuit that detects the voltage and pulls it down so that it is not equal to or greater than a predetermined value, or the like, but a relatively large area is required. Moreover, because it is necessary to make a reference voltage of the voltage detection or the zener diode close to an output target of the regulator, there is a risk of unintended output dropout caused by false detection. Furthermore, there may also be a method in which the reference voltage of the voltage detection is varied according to an input voltage, but an operational amplifier or the like is required, which causes the circuit scale to become large.

### Means to Solve Problems

A voltage regulator related to the disclosure is
a voltage regulator, which outputs a target voltage corresponding to a reference voltage from a power-supply voltage,
the voltage regulator includes:
a feedback loop circuit, in which the reference voltage is input, a feedback voltage after an output voltage is divided is fed back, and the output voltage is controlled in correspondence with the reference voltage; and
a voltage-dividing ratio changing circuit, which changes the feedback voltage by changing a voltage-dividing ratio of the output voltage; wherein
when the power-supply voltage drops and the target voltage cannot be maintained, the feedback voltage is increased according to the power-supply voltage by the voltage-dividing ratio changing circuit, thereby reducing the target voltage.

### Effects

in According to the voltage regulator related to the disclosure, the occurrence of an overshoot can be suppressed by a relatively simple circuit when the voltage of an external power-supply fluctuates greatly to the extent that temporarily drops below a target value of the output and then returns to a normal range again.

### BRIEF DESCRIPTION OF THE DRAWINGS

FIG. 1 is a circuit diagram showing a basic configuration of a voltage regulator according to an embodiment.

FIG. 2 is a diagram showing the operation when a power-supply voltage Vin drops to be equal to or less than an output voltage Vout in a circuit with the basic configuration of FIG. 1.

FIG. 3 is a circuit diagram showing the configuration of the voltage regulator according to the embodiment.

FIG. 4 is a diagram showing an example of the relationship between the power-supply voltage Vin and a current I_pldn.

FIG. 5 is a circuit diagram showing the configuration of a voltage-controlled current source I_pldn.

FIG. 6 is a diagram showing the relationship between the power-supply voltage Vin and the current of the voltage-controlled current source I_pldn.

FIG. 7 is a diagram showing the characteristics of the output voltage Vout in a case where the characteristics of the voltage-controlled current source I_pldn are set to two types as shown in FIG. 6.

FIG. 8 is a diagram showing transient waveforms in a case where the slope of the I-V characteristic is made relatively large using the voltage-controlled current source I_pldn having a delay circuit shown in FIG. 5.

### PREFERRED EMBODIMENT OF THE PRESENT INVENTION

Hereinafter, embodiments of the disclosure will be described below with reference to the drawings. Noted that, the following embodiments do not limit the scope of the disclosure, and configurations obtained by selectively combining multiple examples are also included in the disclosure.

### Basic Configuration

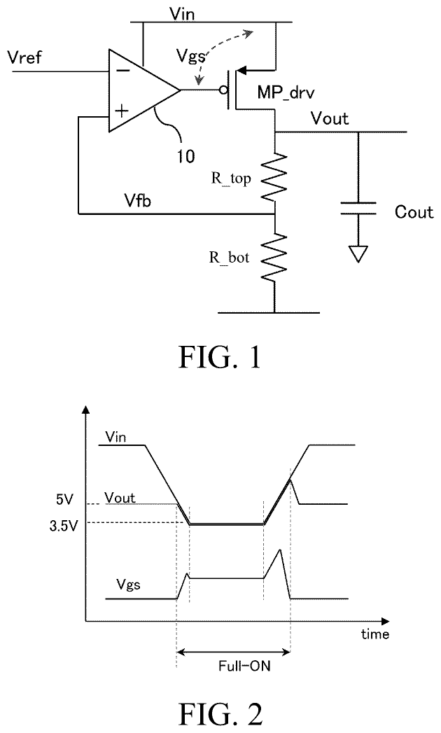

FIG. 1 is a circuit diagram showing a basic configuration of a voltage regulator according to an embodiment. A power-supply voltage Vin is supplied to an operational amplifier 10 from the outside as an operating power-supply. Additionally, a reference voltage Vref is input to a negative input end of the operational amplifier 10, and an output end thereof is connected to the gate of a transistor MP_drv. The operational amplifier 10 is a drive circuit that outputs a gate drive signal of the transistor MP_drv. The transistor MP_drv is a p-channel metal-oxide-semiconductor field effect transistor (MOSFET).

The source of the transistor MP_drv is supplied with the power-supply voltage Vin, and the drain thereof becomes an output end Vout that outputs an output voltage Vout. A capacitor Cout is connected to the output end Vout. The capacitor Cout is the capacitance of an internal circuit and the like connected to the output end Vout. Note that, a smoothing capacitor may also be connected to the output end Vout.

One end of an upper voltage-dividing resistor R_top is connected to the drain of the transistor MP_drv. One end of a lower voltage-dividing resistor R_bot is connected to the other end of the upper voltage-dividing resistor R_top. Furthermore, the other end of the lower voltage-dividing resistor R_bot is connected to the ground.

Additionally, an intermediate point between the upper voltage-dividing resistor R_top and the lower voltage-dividing resistor R_bot is connected to a positive input end of the operational amplifier 10, and the voltage of the intermediate point is fed back to the positive input end of the operational amplifier 10 as a feedback voltage Vfb. That is, the operational amplifier 10, the transistor MP_drv, and a circuit that feeds the intermediate point between the upper voltage-dividing resistor R_top and the lower voltage-dividing resistor R_bot back to the positive input end of the operational amplifier 10 constitute a feedback loop circuit.

In this circuit, the operational amplifier 10 operates in a manner that the feedback voltage Vfb=Vref. That is, the operational amplifier 10 determines a gate-source voltage Vgs of the transistor MP_drv according to the input reference voltage Vref in a manner that the feedback voltage Vfb, which is the drain-side voltage, matches the reference voltage Vref. Thus,

$$Vout = Vref \cdot ( R\_top + R\_bot ) / R\_bot .$$

FIG. 2 is a diagram showing the operation when the power-supply voltage Vin drops to be equal to or less than the output voltage Vout in a circuit with the basic configuration of FIG. 1. In this example, it is assumed that a target voltage of the output voltage Vout is 5 V, and the power-supply voltage Vin drops until becoming 3.5 V. Note that, in this case, it is sufficient to set to R_bot/(R_top+R_bot)=Vref/5.

In the circuit with the basic configuration, a large overshoot is likely to occur when the power-supply voltage Vin fluctuates greatly to the extent that temporarily drops below the output voltage Vout and then returns to a normal range again. This is because if the power-supply voltage Vin is equal to or less than Vout, a loop of feedback control is temporarily broken and the transistor MP_drv goes into the full-on state, and as a result, it takes time to return to the feedback control state again.

### Configuration of Embodiment

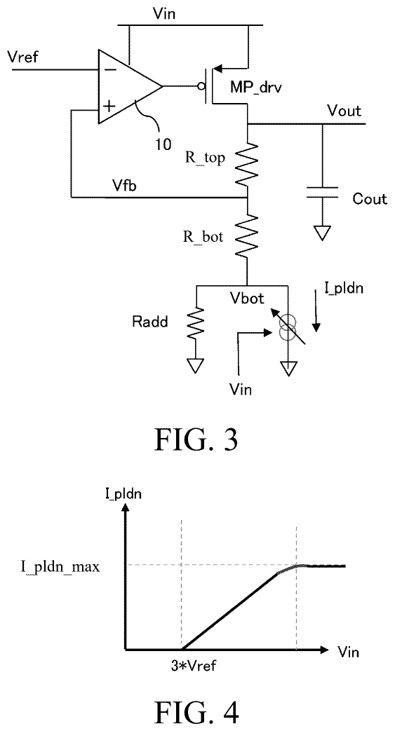

FIG. 3 is a circuit diagram showing the configuration of the voltage regulator according to the embodiment. In this way, one end of each of an additional resistor Radd and a voltage-controlled current source I_pldn is connected in parallel to the lower side of the lower voltage-dividing resistor R_bot, and the other end of each of the additional resistor Radd and the voltage-controlled current source I_pldn is connected to the ground. Additionally, the voltage-controlled current source I_pldn is a voltage-controlled current source in which a flowing current I_pldn varies according to the voltage of the power-supply voltage Vin. Note that, the current flowing through the voltage-controlled current source I_pldn is also denoted as I_pldn. Furthermore, the additional resistor Radd and the voltage-controlled current source I_pldn constitute a voltage-dividing ratio changing circuit.

Other configurations are the same as in FIG. 1, and the intermediate point between the upper voltage-dividing resistor R_top and the lower voltage-dividing resistor R_bot is connected to the positive input end of the operational amplifier 10.

As described above, the additional resistor Radd and the voltage-controlled current source I_pldn are arranged in parallel below the two voltage-dividing resistors R_top and R_bot on the lower side of the output voltage Vout. Thus, the current amount flowing through the additional resistor Radd varies depending on the current amount of the voltage-controlled current source I_pldn. Thus, the two are combined to function as a variable resistor substantially.

In a case where the power-supply voltage Vin is equal to or greater than the target voltage, a maximum current, for example, a current when the resistance flowing through the additional resistor Radd is substantially 0, is made to flow. And, in a case where the power-supply voltage Vin drops to be equal to or less than the normal target voltage, the current flowing through the voltage-controlled current source I_pldn is reduced according to the power-supply voltage Vin. The lowest voltage of the target voltage of the output voltage Vout when the current flowing through the voltage-controlled current source I_pldn is 0 becomes Vout=Vref·(R_top+R_bot+Radd)/(R_bot+Radd).

FIG. 4 is a diagram showing an example of the relationship between the power-supply voltage Vin and the current I_pldn. In a case where three times of the reference voltage Vref is made to correspond to the lowest target voltage, as shown in FIG. 4, by controlling the current value of the voltage-controlled current source I_pldn, the feedback loop can be maintained until the power-supply voltage Vin decreases to 3*Vref.

For example, in a case where the reference voltage is 1 V and the target voltage is 5 V, by setting the resistance ratio of the upper voltage-dividing resistor R_top and the lower voltage-dividing resistor R_bot to 4:1, it becomes the feedback voltage Vfb=1 V. Furthermore, by setting the resistance ratio of the upper voltage-dividing resistor R_top, the lower voltage-dividing resistor R_bot, and the additional resistor Radd to 4:1:1, the target voltage can be set to 3 V.

By maintaining the feedback loop as described above, the control will not fail, and the occurrence of the overshoot of the target voltage at the time of control recovery can be prevented.

Note that, in a case where a variable resistor can be used, a variable resistor that changes the resistance value according to the value of the power-supply voltage Vin may be used instead of the parallel arrangement of the additional resistor Radd and the voltage-controlled current source I_pldn.

### Voltage-Controlled Current Source I_pldn

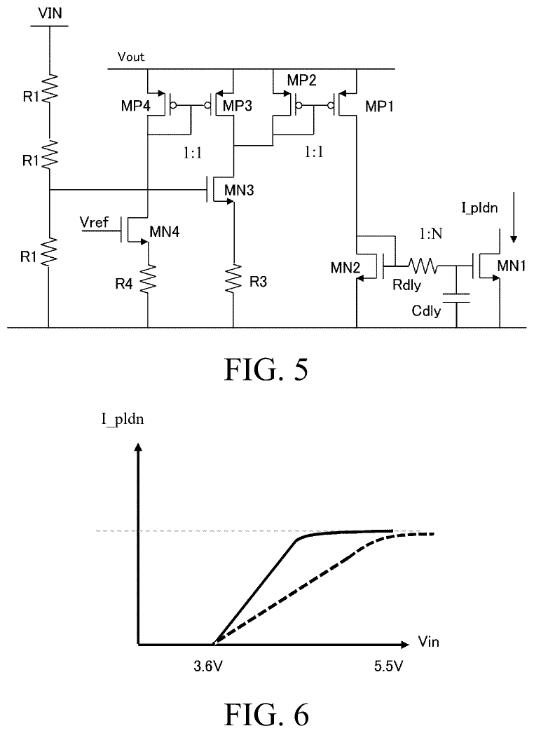

FIG. 5 is a circuit diagram showing the configuration of the voltage-controlled current source I_pldn. A plurality of resistors are arranged between the power-supply voltage Vin and the ground to divide the power-supply voltage Vin, and a divided voltage Vin/n that varies according to the power-supply voltage Vin is obtained. In the illustrated example, three voltage-dividing resistors with a resistance value R1 are arranged, and a divided voltage of Vin/n where n=3, that is, Vin/3, is obtained.

In addition, the source of a p-channel transistor MP4 in which there is a short between the gate and the drain is connected to the output voltage Vout, and the drain of an n-channel transistor MN4 is connected to the drain of the transistor MP4. The reference voltage Vref is supplied to the gate of the transistor MN4, and the source is connected to the ground via a resistor R4. Thus, a current of (Vref-Vgs_MN4)/R4 flows through the transistor MN4 and the transistor MP4.

The gate of a p-channel transistor MP3 is connected to the gate of the transistor MP4. The source of the transistor MP3 is connected to the output voltage Vout, and the transistor MP4 and the transistor MP3 constitute a current mirror. The drain of an n-channel transistor MN3 is connected to the drain of the transistor MP3, and the source of the transistor MN3 is connected to the ground via a resistor R3.

Moreover, the divided voltage of the power-supply voltage Vin is supplied to the gate of the transistor MN3. Thus, a current of (Vin/n-Vgs_MN3)/R3 flows through the resistor R3 and the transistor MN3.

In addition, the drain of a p-channel transistor MP2 in which there is a short between the gate and the drain is connected to a connection point between the transistor MP3 and the transistor MN3. The source of the transistor MP2 is supplied with the output voltage Vout.

Thus, the current flowing through the transistor MP2 is (Vin/n-Vgs_MN3)/R3-(Vref-Vgs_MN4)/R4.

With this configuration, the current flowing through the transistor MP2 varies according to the power-supply voltage Vin. For example, if the transistor MP4 and the transistor MP3 have the same size, the transistor MN4 and the transistor MN3 have the same Vgs, and the resistance values R4=R3=R, a current of (Vin/n-Vref)/R flows through the transistor MP2.

There is a short between the gate and the drain of the transistor MP2, and the gate of a p-channel transistor MP1 is connected to the gate of the transistor MP2. The source of the transistor MP1 is connected to the output voltage Vout, and the transistor MP2 and the transistor MP1 constitute a current mirror.

The drain of an n-channel transistor MN2 is connected to the drain of the transistor MP1. There is a short between the gate and the drain of the transistor MN2, and the source of the transistor MN2 is connected to the ground. For example, if the transistor MP2 and the transistor MP1 have the same size, the same current as the current flowing through the transistor MP2 flows through the transistor MP1 and the transistor MN2.

The gate of the transistor MN2 is connected to the gate of an n-channel transistor MN1 via a resistor Rdly, and the gate of the transistor MN1 is connected to the ground via a capacitor Cdly. The combination of the resistor Rdly and the capacitor Cdly functions as a delay circuit that delays the transmission of signals from the gate of the transistor MN2 to the gate of the transistor MN1.

The source of the transistor MN1 is connected to the ground, and the current flowing through the transistor MN1 becomes the current I_pldn of the voltage-controlled current source I_pldn. That is, the drain of the transistor MN1 is connected to the lower voltage-dividing resistor R_bot in FIG. 3.

Note that, by setting the ratio of the transistor MN2 and the transistor MN1 to 1:N to make the current flowing through the transistor MN2 relatively small, it is possible to make the power consumption of the circuit in FIG. 5 relatively small.

Here, in a case where the power-supply voltage Vin drops, a Vin voltage at which the output target begins to drop is determined by the slope of the I-V characteristic. FIG. 6 is a diagram showing the relationship between the power-supply voltage Vin and the current of the voltage-controlled current source I_pldn. Regarding the two characteristics, the power-supply voltage Vin when the current I_pldn becomes 0 is 3.6 V, but the slopes are different. The characteristic shown by the dashed line has a small slope, while the characteristic shown by the solid line has a large slope. Regarding the characteristic shown by the dashed line, the current I_pldn begins to decrease when the power-supply voltage Vin becomes approximately 5.5 V. On the other hand, regarding the characteristic shown by the solid line, the current I_pldn begins to decrease when the power-supply voltage Vin becomes a value in the vicinity of 4.5 V.

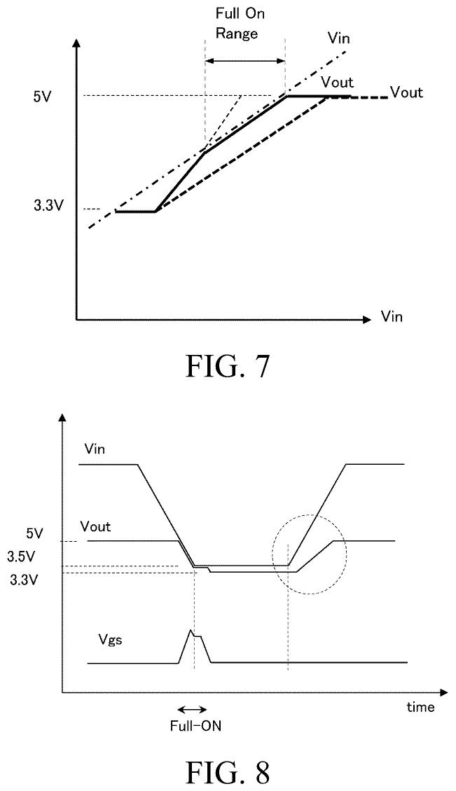

FIG. 7 is a diagram showing the characteristics of the output voltage Vout in a case where the characteristics of the voltage-controlled current source I_pldn are set to two types as shown in FIG. 6. As described above, regarding the characteristic shown by the dashed line, from when the power-supply voltage becomes about 5.5 V, the current I_pldn begins to decrease, the output voltage Vout begins to decrease gradually, and the output voltage Vout decreases until becoming 3.3 V.

On the other hand, regarding the characteristic shown by the solid line, from when the power-supply voltage Vin becomes 5 V, the feedback loop is broken, the transistor MP_drv is made full-on, and the output voltage Vout decreases together with the power-supply voltage Vin. And then, the current I_pldn begins to decrease, and the target voltage decreases, causing the output voltage Vout to decrease as well, with the output voltage Vout dropping until becoming 3.3 V. As described above, if the slope of the I-V characteristic is increased, MP_drv becomes full-on in a certain range of Vin, and the output voltage Vout becomes the same level as the power-supply voltage Vin.

It can be said that the output voltage Vout having the characteristic shown by the solid line is preferable for circuit blocks which use it as a power-supply, because the drop of the said output voltage Vout can be made relatively small. However, if the power-supply voltage Vin suddenly returns to its original state, the feedback loop control cannot be restored in time, and the overshoot cannot be prevented.

Here, the circuit of FIG. 5 has the delay circuit constituted by the resistor Rdly and the capacitor Cdly. Thus, the change in the current I_pldn with respect to the change in the difference between the power-supply voltage Vin and the reference voltage Vref is delayed.

FIG. 8 is a diagram showing transient waveforms in a case where the slope of the I-V characteristic is made relatively large using the voltage-controlled current source I_pldn having the delay circuit shown in FIG. 5.

As described above, in a case where the power-supply voltage Vin intends to become equal to or less than the output voltage Vout, the reduction of the current I_pldn is delayed by the delay circuit, the feedback loop is broken, and the transistor MP_drv is made full-on temporarily. However, the current I_pldn then decreases, and thereby the feedback loop is maintained. Thereafter, when the power-supply voltage Vin rises and returns to be equal to or greater than the output voltage Vout, the feedback loop is maintained, making it possible to prevent the occurrence of the overshoot. As shown in FIG. 8, by delaying the restoration of the current I_pldn, the slope of the rise of the output voltage Vout becomes slightly smaller.

By arranging the delay circuit in this way, a large drop of the output voltage Vout when the power-supply voltage Vin drops can be suppressed, and the occurrence of the overshoot when the voltage of the power-supply voltage Vin rises can be prevented.

### Effects of Embodiment

In the embodiment, by changing the current value of the voltage-controlled current source I_pldn, the voltage-dividing ratio can be seamlessly changed, and thereby the feedback loop can be maintained. Accordingly, the transistor MP_drv can be avoided from becoming full-on, and the overshoot of the output voltage Vout during the recovery of the power-supply voltage Vin can be avoided.

In addition, by making the slope of the I-V characteristic of the voltage-controlled current source L_pldn with respect to the power-supply voltage Vin relatively large and adding the delay circuit, the overshoot can be avoided while maintaining a wide range of the output voltage.

Because the control according to the embodiment is a feedforward control that responds to the power-supply voltage Vin, it is not necessary to handle a large current corresponding to the output of the transistor MP_drv, and the circuit scale regarding control can be made relatively small.

In the circuit of FIG. 5, a differential input configuration is used, the power-supply voltage Vin and an accurate reference voltage are compared, and the current amount of the voltage-controlled current source I_pldn is controlled. Thus, a threshold voltage of the power-supply voltage Vin which begins to change can be set accurately.

### DESCRIPTION OF THE REFERENCE NUMERALS

10: operational amplifier
I_pldn: voltage-controlled current source
R_bot: lower voltage-dividing resistor
R_top: upper voltage-dividing resistor
Radd: additional resistor
Vin: power-supply voltage
Vref: reference voltage
Vout: output voltage

What is claimed is:

1. A voltage regulator, which outputs a target voltage corresponding to a reference voltage from a power-supply voltage,
the voltage regulator comprising:
a feedback loop circuit, in which the reference voltage is input, a feedback voltage after an output voltage is divided is fed back, and the output voltage is controlled in correspondence with the reference voltage; and
a voltage-dividing ratio changing circuit, which changes the feedback voltage by changing a voltage-dividing ratio of the output voltage; wherein
when the power-supply voltage drops and the target voltage cannot be maintained, the feedback voltage is increased according to the power-supply voltage by the voltage-dividing ratio changing circuit, thereby reducing the target voltage.

2. The voltage regulator according to claim 1, wherein
the voltage-dividing ratio changing circuit comprises:
a voltage-dividing resistor, which outputs the feedback voltage from an intermediate point; an additional resistor, which is connected on a downstream side of the voltage-dividing resistor; and a voltage-controlled current source, which is connected in parallel to the additional resistor and whose current amount is changed according to the power-supply voltage.

3. The voltage regulator according to claim 1, wherein
the voltage-dividing ratio changing circuit comprises a delay circuit, and a fluctuation in the power-supply voltage is delayed by the delay circuit and transmitted to the voltage-controlled current source.
